(19) United States
(12) Patent Application Publication
(10) Pub. No.: US 2006/0182953 A1
(43) Pub. Date: Aug. 17, 2006

(54) Mold treatment and removal apparatus and methods

(76) Inventor: Erick C. Jensen, Carlisle, PA (US)

Correspondence Address: MCNEES, WALLACE & NURICK LLC, 100 PINE STREET, P.O. BOX 1166, HARRISBURG, PA, 17108-1166, US

(21) Appl. No.: 11/353,495

(22) Filed: Feb. 14, 2006

Related U.S. Application Data
(60) Provisional application No. 60/653,009, filed on Feb. 15, 2005.

(51) Int. Cl. B32B 7/12

(52) U.S. Cl. 428/343; 156/325

(57) ABSTRACT

Apparatus for use in treating and removing environmental mold, mildew, and other undesirable biological contaminants are provided. The apparatus comprises a sheet substrate having at least a first side coated with a coating comprising a pressure sensitive adhesive and at least one chemical effective in treating undesirable biological contaminants such as mold, mildew, fungi, and other pathogens. Methods of use of the apparatus include applying the apparatus to a surface having biological contaminants thereon for a time sufficient to lyse at least a portion of the contaminant.

### CROSS-REFERENCE TO RELATED APPLICATIONS

This application claims priority to U.S. Provisional Patent Application Ser. No. 60/653,009, filed on Feb. 15, 2005.

### BACKGROUND OF THE INVENTION

The present invention relates generally to apparatus and methods for use in treating and removing environmental mold, mildew, and other undesirable biological contaminants. In particular, the present invention relates to a tape-like sheet substrate having at least a first side coated with an adhesive including at least one chemical effective in treating undesirable biological contaminants such as mold, mildew, fungi, and other pathogens.

The use of chemicals for eradicating pathogens and microbiological organisms on environmental surfaces is known in the prior art. The use of bleaches, acids, and other harsh chemicals is effective to lyse and remove pathogens and undesirable microorganisms, but application of such chemicals by fuming, spraying, immersing, painting, or sponging increases the risk of undesired human exposure to the chemicals, as well as to the pathogens. To avoid adverse effects of such exposure, personnel are required to wear protective clothing and respirators which compromise freedom of movement and may undesirably limit full access to mold-infested areas. Additionally, the use of known chemicals and techniques has the undesired effect of liberating mold and mold spores, necessitating further precautions to protect operators and bystanders from direct and indirect exposure. For example, windows and doorways of rooms to be treated are sealed using tape and plastic sheeting, and HEPA vacuums and air filters are used to remove mold and pathogens from the air of the room being treated.

What is needed is a medium for delivering remediation chemicals directly to the site of biological contamination to effectively eradicate biological contaminants with minimal exposure to surrounding areas or the operator.

What is further needed is a medium that, after delivering eradicating chemicals to a contaminated surface, effectively removes at least a portion of the lysed contaminants without substantial damage to the underlying treated surface.

### SUMMARY OF THE INVENTION

One embodiment of the present invention is directed to a sheet substrate having a first side and an opposite second side, the first side including a coating, the coating including an adhesive and at least one chemical effective for remediating a biological contaminant.

In another embodiment, the methods of the present invention include providing a surface having a biological contaminant thereon, providing a sheet substrate having a first side and an opposite second side, the first side including a coating, the coating including an adhesive and at least one antimicrobial chemical effective for remediating a biological contaminant. The method further comprises the step of adhering the sheet substrate to the surface for a time sufficient to lyse at least a portion of the biological contaminant, and removing the substrate from the surface.

An advantage of the present invention is that it permits applications of a biocide to a particular portion of a surface, without exposing the surrounding environment to the biocide. Another advantage is that after application of the sheet substrate to a surface for a sufficient to lyse a biological contaminant, the substrate can be easily removed without leaving tape residue. Additionally, the removal process does not require any special tools, and usually results in removal of at least a portion of the lysed contaminant (such as mold) which remains affixed to the adhesive coating.

### BRIEF DESCRIPTION OF THE DRAWINGS

FIG. 1 illustrates a cross-sectional side view of one embodiment of a substrate for treatment of a biological contaminant in accordance with the present invention.

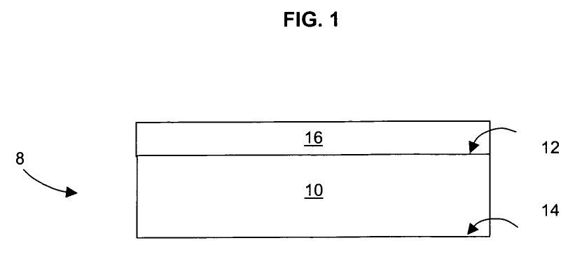

FIG. 2 illustrates a first embodiment of a method of treating a biological contaminant in accordance with the present invention.

Wherever possible, the same reference numbers will be used throughout the drawings to refer to the same or like parts.

### DETAILED DESCRIPTION OF THE INVENTION

The subject matter of the invention under consideration is directed to a tape-like substrate having at least one side coated with an adhesive composition, the adhesive composition including at least one chemical effective in treating undesirable microbiological contaminants such as mold, mildew, as well as other pathogens such as fungi, bacteria, viruses, and insects that may be found on surfaces such as wood, laminates, plastics, stone, concrete and the like in man-made structures. The chemical will hereinafter be referred to as an “antimicrobial chemical”, and the use of the term “antimicrobial” is defined as having lysing activity against any known undesirable organism, including by not limited to mold and mildew, as well as other pathogens such as fungi, bacteria, viruses, and insects.

In one embodiment, the apparatus 8 comprises a sheet substrate 10 having a first side 12 and an opposite second side 14, the first side 12 including a coating 16, the coating 16 including an adhesive and at least one antimicrobial chemical effective for remediating a biological contaminant.

The substrate 10 is a sheet material that is flexible and malleable, yet strong enough to remain intact when adhered to a surface and subsequently peeled or otherwise removed from the surface. The sheet material 10 may include papers, woven and non-woven cloths, sheet polymers, foils, combinations thereof, and any other material suitable for receiving an adhesive coating and retaining physical characteristics of flexibility, malleability, and strength upon applying to and removing from a uniform or non-uniform surface to be treated. Additionally, the substrate 10 must be compatible with coating processes for applying an adhesive composition including one or more antimicrobial chemical agents. The coating processes may include any known substrate coating process, including spraying, dipping, wet rolling, extruding, and the like. Preferably, the substrate is a fiber-reinforced paper, although fabrics and other known durable substrates are also suitable.

The coating 16 includes an adhesive and at least one antimicrobial chemical effective for remediating a biological contaminant. The adhesive may be any known adhesive that will temporarily adhere to a surface yet permanently adhere to the substrate 10, so that the adhesive coating 16 remains attached to the substrate 10 upon application of apparatus 8 to, and removal from, a surface to be treated. Upon application of the apparatus 8 to a surface to be treated, the coating 16 is in contact with the surface and the antimicrobial chemical kills biological contaminants located on the surface. The adhesive of the coating 16 must be such that it retains its tacky nature yet allows the dispersion of the effective chemical to the surface to be treated. Additionally, the coating and substrate are pliable and moldable so that by exerting pressure, a user can force the coating and chemical into grooves and other surface features. Preferably, the adhesive is sponge-like, so that a user can expel some of the chemical onto a surface by exerting pressure on the uncoated side of the substrate once the adhesive is applied to a surface. Expelling the chemical in this manner allows capillary action to draw the chemical into the contaminated surface features. However, the small amount of chemical exposed, and the proximity of the coating to the surface to be treated, prevent any significant chemical exposure to the user. The adhesive may be water based or solvent based depending upon the desired time of treatment, desired release rate of the effective chemical, and also based upon shelf-life and human and environmental safety concerns. In a preferred embodiment, the adhesive is a hot melt pressure sensitive adhesive. Exemplary hot melt pressure sensitive adhesives include those commercially available from Ashland Corp. as Number ASH-7062, National Starch and Chemical Company as number 34-6101. Other suitable pressure-sensitive polymeric adhesives include silicone adhesive compositions, acrylic adhesive compositions, rubber adhesive compositions, urethane adhesive compositions and epoxy adhesive compositions, and combinations thereof. However, all pressure sensitive adhesives that are compatible with the selected antimicrobial chemical and selected sheet substrate to create a tape-like, removable, repositionable coated substrate are within the scope of the present invention.

The antimicrobial chemical effective for remediating a biological contaminant can be any known moldicide, mildewicide, fungicide, insecticide, or other biocide. Preferably, the chemical is at least one of benzylalkonium chloride or its other salts, disodium octaborate tetrahydrate-containing compositions such as TIMBOR® (registered trademark of Nisus Corporation of Rockford, Tenn.), Copper 8 quinolinolate, chromated copper arsenate (CCA), ammoniacal copper quaternary (ACQ) compounds such as quaternary ammonium chloride containing compositions such as SHOCKWAVE® (registered trademark of Fiberlock Technologies Inc. of Andover, Md.), copper azole (CA), isothiazolin, disodium octoborate tetrahydrate, borate-containing compositions such as Bora-Care® (registered trademarks of Nisus Corporation of Rockford, Tenn.), acticide 45, bifenthrin, pyrethins, hypochlorous acid, sodium percarbonate, zinc oxide, titanium dioxide, sodium salts (CAS# 7681-52-9), sodium hydroxide (CAS# 1310-73-2), phenol and sodium phenate containing compositions such as SPORICIDIN® brand disinfectant solution (SPORICIDIN® (is a registered trademark of the Sporicidin Company of Rockville, Md.), combinations thereof. More preferably, the chemical includes benzylalkonium and disodium octaborate tetrahydrate such as Timbor®. Most preferably, the chemical includes quaternary ammonium chloride. Additionally or alternatively, the coating may include biological agents that are active against undesirable biologic organisms such as mold and other biological pathogenic organisms. Combinations of the above-listed chemicals and agents, as well as other chemicals and agents known to be effective against mold, mildew, and/or insects are within the scope and spirit of the present invention.

Benzylalkonium, disodium octaborate tetrahydrate, and quaternary ammonium chloride, and combinations thereof, are preferred for use as antimicrobial chemicals in the adhesive coating 16. Commercially available embodiments of those chemicals can provide additional benefits in the preferred embodiments. For example, TIMBOR®, in addition to its fungicidal properties, is also a fire retardant, insecticide, and wood preservative. Thus, remediation of a mold-infested wood surface using the apparatus 8 of the present invention, including TIMBOR® brand disodium octaborate tetrahydrate cleaner as a chemical in the adhesive coating 16, may also render the treated wood fire retardant, insect-proof, and preserved against further environmental degradation.

The coating 16 is preferably between about 2 and about 30 mils in thickness. For non-painted surfaces and other applications where the surface to be treated is very durable, the thickness is preferably between about 15-30 mils in thickness. For painted surfaces and other surfaces that may be susceptible to delamination, the adhesive coating 16 is preferably between about 2 to about 10 mils in thickness. Other factors affecting the thickness include the amount of effective chemical to be delivered, the desired treatment time, and the desired rate of delivery. For example, using a thinner coating having a low percentage content of the effective chemical may require leaving the coating in contact with the desired surface for a longer time, whereas selection of a thicker coating having a similar percentage of effective chemical by weight may require a shorter treatment time. Preferably, the adhesive comprises a polymer that readily accepts the effective chemical and provides a sustained release of the chemical over a period of about 12 to about 72 hours. More preferably, the antimicrobial chemical is fully released to the surface to be treated over a period of between about 1 to about 3 hours.

The resulting apparatus 8 can be further processed, such as by applying a release sheet over the coating 16 and optionally cutting and rolling the apparatus 8, as further described herein. The apparatus 8 of the present invention is preferably provided as a bendable, rollable tape-like product. More preferably, the apparatus 8 is a tape-like product provided in rolls approximately ten to about twelve inches wide and approximately ten to about twenty feet long. Depending upon the tack of the adhesive coating 16 and the stability and toxicity of the chemicals therein, the apparatus 8 may further include a release sheet applied over the coating 16 to preserve the adhesive properties and prevent unintended human contact with the coating 16 during packaging, unpackaging, and use of the apparatus 8.

The mold stripping apparatus 8 of the present invention can be created by any of several methods. Preferably, the apparatus 8 is a tape created by the steps of selecting appropriate monomers such as vinyls, acrylics and combinations thereof. The monomers are mixed with one or more solvents and polymerization agents such as photoactivators to promote polymerization to yield a cross-linkable polymeric adhesive composition. Suitable monomers, solvents, and polymerization agents are taught in U.S. Pat. No. 5,391,406, which is hereby incorporated by reference in its entirety. The polymeric adhesive composition is then converted to a hot melt by any known method, such as removal of the solvent, coagulation of the latex, or melt-processing of the neat polymer. The hot melt is then heated and applied to a backing or substrate, preferably by an extrusion method. Preferably, the ingredients of the composition are selected such that the hot melt need only be heated to a temperature above about 80 degrees Celcius to render the composition fluid and coatable to the backing or substrate. The hot melt is then subsequently irradiated for a time sufficient to cross-link the polymeric adhesive composition, thus transforming the material from a low cohesion to an elastomeric adhesive of predetermined plasticity, such that, upon cooling, the adhesive composition is rendered pressure sensitive. Thus, the elastomeric adhesive remains more strongly bonded to the substrate that to any other surface to which the exposed surface of the adhesive coating 16 might be applied.

The antimicrobial chemical can be incorporated at any of several steps in the above method. Preferably, the antimicrobial chemical is selected to be UV-stable, and may therefore be incorporated into the polymeric adhesive composition prior to the irradiation step. For example, the antimicrobial chemical may be added to the cross-linkable polymeric adhesive composition as a liquid and mixed to yield a substantially homogeneous liquid mixture. Alternatively, where the antimicrobial chemical is not UV stable, it may be applied subsequent to the irradiation step, such as by heating the coated substrate and spraying, brushing, or atomizing the antimicrobial onto the outer (exposed) adhesive, then cooling the coated substrate to restore the adhesive composition to its pressure sensitive state.

In one embodiment of methods of forming the coating 16, the selected adhesive is mixed with at least one effective antimicrobial chemical to produce a substantially homogeneous adhesive-antimicrobial chemical mixture that can be applied to at least one side 12 of the substrate 10 using known coating methods to form the coating 16. Preferably, the adhesive is a hot melt type and the antimicrobial chemical includes disodium octaborate tetrahydrate. The resulting mixture is heated to a predetermined temperature sufficient to maintain the mixture in its liquid state, but not high enough to cause the antimicrobial chemical to evaporate, thermally decompose, or otherwise affect its desired antimicrobial properties. The predetermined temperature is thus determined based upon factors such as the solidus-liquidus transition temperature of the adhesive, as well as the volatility and thermal stability of the selected chemical(s) effective against the organisms to be eradicated. The resulting liquid mixture is next applied to the surface of one side 12 of the substrate 10 by any known method such as by spraying, roller-coating, extruding and the like, and allowed to cool to form a substantially uniform pressure sensitive coating 16 on the substrate 10.

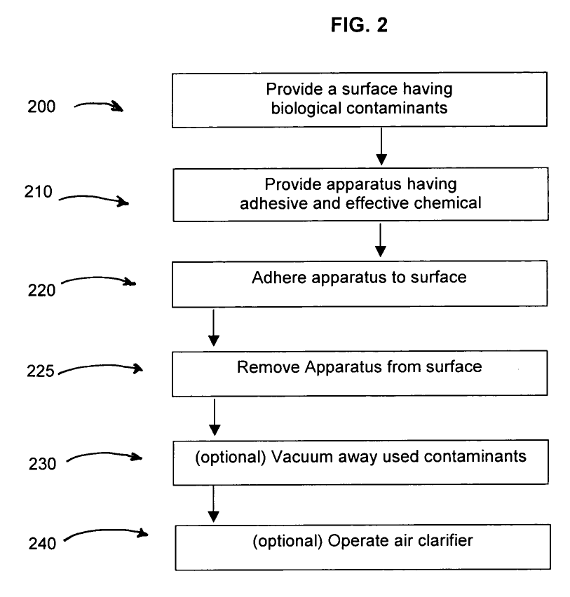

Methods of use of the apparatus 8 are also provided. As shown in FIG. 2, in one embodiment, the methods of using the apparatus 8 of the present invention include the step 200 of providing a surface having biological contaminants thereon. The method further includes the step 210 of providing an apparatus 8 including a sheet substrate 10 having a first side 12 and an opposite second side 14, the first side 12 including a coating 16, the coating including an adhesive and at least one chemical effective for remediating a biological contaminant. The method further includes the step 220 of adhering the apparatus 8 to the surface for a time sufficient to permit the coating 16 to lyse at least a portion of the biological contaminant. The time required will depend upon the chemical used, the amount and type of biological contaminant being treated, the nature of the surface being treated, the nature of the surrounding environment and environmental conditions, and the desired result (i.e., lysing all versus less than all of the biological contaminant in a single treatment). As previously discussed, a user may optionally exert pressure on the uncoated side 14 of the substrate to conform the coating 16 to the surface features. After remaining on the surface to be treated for a sufficient predetermined time, the apparatus 8 is removed in step 225. Optionally, the methods further include the step 230 of vacuuming away the eradicated microorganisms and by-products by attaching a HEPA vacuum. The methods may further include the step 240 of operating an air clarifier in the environment of the remediated surface to clean the air of airborne microorganisms and by-products of the surface remediation.

By way of further example, in one embodiment of the methods of using the apparatus 8 of the present invention, the apparatus 8 of the present invention is a tape-like product having a coating 16 including at least one antimicrobial chemical such as disodium octaborate tetrahydrate, benzalkonium chloride or a combination thereof. The apparatus 8 is applied to a mold-infested material such as floor joist, studs, trusses, beams, flooring, paneling, siding, sub-flooring, sheetrock, and plaster wall materials. The required length and width desired for complete coverage of the mold-infested area is determined, and is then cut from the roll of the apparatus 8. The cut material is then trimmed to substantially conform to different sized areas and contours of each surface to be treated. A release paper is removed from the adhesive coating 16, thereby exposing the coating 16. The apparatus 8 is applied to the infested surface with the adhesive coating 16 facing the surface to be treated. Pressure is applied to the uncoated side 14 of the apparatus 8 as the tape is molded and affixed to the desired area to be treated. The apparatus 8 is allowed to remain affixed to the mold infested material for a period sufficient to eradicate the mold or other pathogen, preferably between about one to about twenty-four hours. The apparatus 8 can then be removed by simply pulling on the uncoated side 14 of the substrate 10 to peel it from the treated surface. Alternatively, where the treated area is not visible to passers by or is otherwise not cosmetically important, the product can be left on for extended period of time to render additional benefit such as the wood stabilizing, insecticidal, and other properties previously described for the preferred embodiment of the coating 16. Where the apparatus 8 is removed after treatment, an additional benefit of the adhesive coating 16 is that surface mold and other contaminants will also become attached to the adhesive coating 16, so that the surface mold and contaminants are removed along with the apparatus 8 without damaging the materials or paint that was formerly mold covered. The used apparatus 8 is then discarded, taking into account any EPA or other regulatory and safety requirements applicable to the disposal of the removed pathogen, as well as the contents of the apparatus 8.

In other embodiments, the methods of using the apparatus 8 are combined with other methods of remediating biological contaminants. For example, a room to be treated may include contaminated flat surfaces such as painted sheetrock walls and linoleum flooring, as well as curved surfaces such as porcelain toilet fixtures that are exposed, allowing for easy application of the adhesive substrate. The same room can include crevices that are not accessible to human hands and therefore are not exposed and available for treatment using the adhesive substrate. Crevices and other non-compatible contaminated surfaces can be treated using alternative apparatus such as the ultraviolet light gun described by Applicant in co-pending U.S. Provisional Patent Application 60/590,169 filed Jul. 22, 2004, which is incorporated herein by reference. The ultraviolet light gun is particularly appropriate for use in conjunction with the apparatus of the present invention not only because of its ability to reach unexposed surfaces, but because the gun can be safely operated with a minimum of UV protective gear. Thus, methods of remediation contemplated herein include the use of both an adhesive substrate and an ultraviolet light to completely eradicate undesired biological contaminants in an area to be treated.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A pressure sensitive apparatus for remediating a biological contaminant, the apparatus comprising:
a sheet substrate having a first side and an opposite second side; and
a pressure sensitive adhesive coating overlying at least a portion of the first side, the coating comprising a polymeric adhesive composition and at least one antimicrobial chemical effective for remediating a biological contaminant.

2. The apparatus of claim 1, wherein the polymeric adhesive composition is a hot melt pressure sensitive adhesive.

3. The apparatus of claim 1, wherein the antimicrobial chemical is substantially uniformly dispersed throughout the coating.

4. The apparatus of claim 1, wherein the antimicrobial chemical is selected from the group consisting of: moldicides, mildewicides, fungicides, insecticides, biocides, and combinations thereof.

5. The apparatus of claim 4, wherein the antimicrobial chemical is selected from the group consisting of benzylalkonium chloride and its salts, disodium octaborate tetrahydrate, copper 8 quinolinolate, chromated copper arsenate, ammoniacal copper quaternary, copper azole, isothiazolin, disodium octoborate tetrahydrate, borates, acticide 45, bifenthrin, pyrethins, hypochiorous acid, sodium percarbonate, zinc oxide, titanium dioxide, sodium salts, sodium hydroxide, phenol, sodium phenate, and combinations thereof.

6. The apparatus of claim 4, wherein the antimicrobial chemical is selected from the group consisting of: benzylalkonium, disodium octaborate tetrahydrate, quaternary ammonium chloride, and combinations thereof.

7. The apparatus of claim 1, further including a fire retardant chemical.

8. The apparatus of claim 1, wherein the coating has a thickness of between about 2 and about 30 mils, and wherein upon application of the apparatus to a surface to be treated, the coating provides a sustained release of the chemical to the surface to be treated over a predetermined period of time.

9. The apparatus of claim 8, wherein the predetermined period of time is between about 1 to about 72 hours.

10. The apparatus of claim 8, wherein the predetermined period of time is between about 1 to about 3 hours.

11. A method of remediating a surface having a biological contaminant thereon, the method comprising the steps of:
providing a surface having a biological contaminant thereon;
providing a pressure sensitive apparatus effective for remediating a biological contaminant, the apparatus comprising a sheet substrate having a first side and an opposite second side and a pressure sensitive coating overlying at least a portion of the first side of the sheet substrate, the coating comprising a polymeric adhesive composition and at least one antimicrobial chemical effective for remediating a biological contaminant; and
adhering the sheet substrate to the surface for a time sufficient to release at least a portion of the antimicrobial chemical from the coating in an amount sufficient to lyse at least a portion of the biological contaminant.

12. The method of claim 11, wherein the step of providing a surface having a biological contaminant includes providing a surface contaminated by a biological contaminant selected from the group consisting of mold, mildew, fungi, insects, pathogens, and microorganisms.

13. The method of claim 11, wherein the step of providing a pressure sensitive apparatus includes providing a coating including a polymeric adhesive composition comprising a hot melt pressure sensitive adhesive.

14. The method of claim 11, wherein the step of providing a pressure sensitive apparatus includes providing a coating including an antimicrobial chemical selected from the group consisting of: moldicides, mildewicides, fungicides, insecticides, biocides, and combinations thereof.

15. The method of claim 14, wherein the antimicrobial chemical is selected from the group consisting of benzylalkonium chloride and its salts, disodium octaborate tetrahydrate, copper 8 quinolinolate, chromated copper arsenate, ammoniacal copper quaternary, copper azole, isothiazolin, disodium octoborate tetrahydrate, borates, acticide 45, bifenthrin, pyrethins, hypochlorous acid, sodium percarbonate, zinc oxide, titanium dioxide, sodium salts, sodium hydroxide, phenol, sodium phenate, and combinations thereof.

16. The method of claim 16, wherein step of providing a pressure sensitive apparatus includes providing a pressure sensitive apparatus that further includes a fire retardant chemical.

17. The method of claim 16, wherein the step of providing a pressure sensitive apparatus further includes providing a pressure sensitive apparatus wherein the coating is between about 2 and about 30 mils thick, and wherein the coating provides a sustained release of the chemical over a predetermined period of time.

18. The method of claim 12, further comprising the step of applying sufficient pressure to the opposite second side of the substrate to cause the coating to immediately release at least a portion of the antimicrobial chemical in liquid form onto the surface to be treated.

19. The method of claim 12, further comprising the step of removing the apparatus from the surface.

20. A pressure sensitive apparatus effective for remediating a biological contaminant on a surface to be treated, the apparatus comprising:
a sheet substrate having a first side and an opposite second side; and
a pressure sensitive adhesive coating overlying at least a portion of the first side of the substrate, the coating including a hot melt polymeric adhesive composition and at least one antimicrobial chemical effective for remediating a biological contaminant;
wherein the antimicrobial chemical comprises at least one of benzylalkonium chloride and its salts, disodium octaborate tetrahydrate, copper 8 quinolinolate, chromated copper arsenate, ammoniacal copper quaternary, copper azole, isothiazolin, disodium octoborate tetrahydrate, borates, acticide 45, bifenthrin, pyrethins, hypochlorous acid, sodium percarbonate, zinc oxide, titanium dioxide, sodium salts, sodium hydroxide, phenol, and sodium phenate, and wherein the coating is between about 2 and about 30 mils in thickness; and
wherein, upon application to a surface to be treated, the coating provides a sustained release of the antimicrobial chemical to a surface to be treated over a predetermined period of time.
